(19) United States
(12) Patent Application Publication
(10) Pub. No.: US 2026/0326614 A1
(43) Pub. Date: Oct. 22, 2026

(54) BATTERY TESTING CONTROL SYSTEM FOR A BATTERY ELECTRIC MACHINE

(71) Applicant: Caterpillar Inc., Peoria, IL (US)

(72) Inventors: Karl P. Schneider, Decatur, IL (US); Andrew Olson, Vail, AZ (US)

(73) Assignee: Caterpillar Inc., Peoria, IL (US)

(21) Appl. No.: 19/180,451

(22) Filed: Apr. 16, 2025

(51) Int. Cl. B60L 58/16; B60L 58/12

(52) U.S. Cl. CPC B60L 58/16; B60L 58/12; B60L 2200/40

(57) ABSTRACT

A system may include a battery to operate a motor of a work machine, a sensor to measure an electrical property of the battery, an energy-dissipation device on the work machine and electrically connected to the battery, and a controller. The controller may detect that a charging connection point of the work machine is connected to a charger, initiate a performance test for the battery while the battery is connected to the work machine, cause charging of the battery to an upper level, cause discharging of the battery to a lower level using the energy-dissipation device to obtain, from the sensor, discharge data indicating the electrical property during discharging of the battery, cause charging of the battery back to the upper level to obtain, from the sensor, charge data indicating the electrical property during charging of the battery, determine a battery capacity, and output information indicating the battery capacity.

### TECHNICAL FIELD

The present disclosure relates generally to battery electric machines and, for example, to battery testing control system for a battery electric machine.

### BACKGROUND

Electrical machinery, such as vehicles or other mobile machinery, which are at least partially powered by on-board batteries, can be an environmentally friendly alternative to machinery running on fossil fuels. These battery electric machines help reduce greenhouse gas emissions and dependency on non-renewable energy sources. However, they also face several challenges, particularly in terms of battery performance.

The battery is a significant factor in the operation of battery electric machines, driven by the high cost of a single battery pack and the need for multiple replacements over the lifecycle of the machine due to capacity limitations (e.g., capacity degradation). The capacity limitations may include an increase in internal resistance, which can serve as an end-of-life metric. For example, a prolonged operation at an elevated temperature can exceed the cooling system's capacity, leading to thermal stress, accelerated degradation, and the need to derate battery performance. Battery end-of-life is typically defined by a reduction in capacity from its original state. Onboard systems may track this degradation through various methods, but accuracy can be hindered by sensor uncertainty, indirect measurement (e.g., terminal versus internal voltage), and a limited depth-of-discharge range (e.g., through a typical operating range) with a low-sloped open-circuit voltage curve. Premature battery replacement increases lifecycle costs, while excessive use of a degraded battery can negatively impact machine performance and lead to unexpected failures, disrupting fleet operations. Furthermore, the operation performance may be impacted by machines becoming unavailable due to frequent charging requirements and/or an inability to complete certain cycles due to energy limitations.

To optimize battery management, confirm a machine battery system health, and/or evaluate charging performance metrics (e.g., of a battery, a cooling system, a power electronics, etc.), it is useful to verify capacity at commissioning, and periodic capacity checks during planned maintenance provide valuable insights for tracking performance trends, projecting future capacity loss, and assessing the impact of past usage conditions on battery longevity.

U.S. Pat. No. 10,996,280 (the '280 patent) discloses a battery pack that includes a secondary battery and a full charge capacity calculator. The full charge capacity calculator calculates a full charge capacity of the secondary battery based on a differential state of charge and an integrated current amount. The '280 patent does not disclose a battery performance test that is performed while the battery is connected to a machine and the machine is connected to a charger. Accordingly, the techniques of the '280 patent do not efficiently utilize planned machine downtime for full charge capacity calculation.

The testing control system of the present disclosure solves one or more of the problems set forth above and/or other problems in the art.

### SUMMARY

A testing control system for a work machine may include a battery configured to operate one or more electric drive motors of the work machine, a sensor configured to measure an electrical property of the battery, an energy dissipation device arranged on the work machine and electrically connected to the battery, and a controller. The controller may be configured to detect that a charging connection point of the work machine is connected to a charger. The controller may be configured to initiate, based on detecting that the charging connection point is connected to the charger, a performance test for the battery while the battery is connected to the work machine. The controller may be configured to cause, for the performance test, charging of the battery to an upper charge level. The controller may be configured to cause, for the performance test, discharging of the battery to a lower charge level using the energy dissipation device to obtain, from the sensor, discharge data indicating the electrical property during discharging of the battery. The controller may be configured to cause, for the performance test, charging of the battery back to the upper charge level to obtain, from the sensor, charge data indicating the electrical property during charging of the battery. The controller may be configured to determine, using the discharge data and the charge data, a capacity of the battery. The controller may be configured to output information indicating the capacity of the battery.

A work machine may include a propulsion system, an electric drive motor configured to drive the propulsion system, a battery configured to operate the electric drive motor, and a controller. The controller may be configured to monitor, during a performance test for the battery while the battery is connected to the work machine, an electrical property of the battery. The controller may be configured to cause, for the performance test, discharging of the battery to a lower charge level to obtain discharge data indicating the electrical property during discharging of the battery. The controller may be configured to cause, for the performance test, charging of the battery to an upper charge level to obtain charge data indicating the electrical property during charging of the battery. The controller may be configured to determine, using the discharge data and the charge data, a performance metric for the battery.

A method may include monitoring, by a controller and during a performance test for a battery connected to a work machine, an electrical property of the battery. The method may include causing, by the controller for the performance test, charging of the battery to an upper charge level. The method may include causing, by the controller for the performance test, discharging of the battery to a lower charge level to obtain discharge data indicating the electrical property during discharging of the battery. The method may include causing, by the controller for the performance test, charging of the battery back to the upper charge level to obtain charge data indicating the electrical property during charging of the battery. The method may include determining, by the controller and using the discharge data and the charge data, a performance metric for the battery. The method may include causing, by the controller and based on the performance metric, an adjustment to one or more operating parameters of the work machine.

### BRIEF DESCRIPTION OF THE DRAWINGS

FIG. 1 is a perspective view of an example machine.

FIG. 2 is a diagram of an example of a testing control system.

FIG. 3 is a flowchart of an example method.

### DETAILED DESCRIPTION

This disclosure relates to a testing control system, which is applicable to any battery-electric machine.

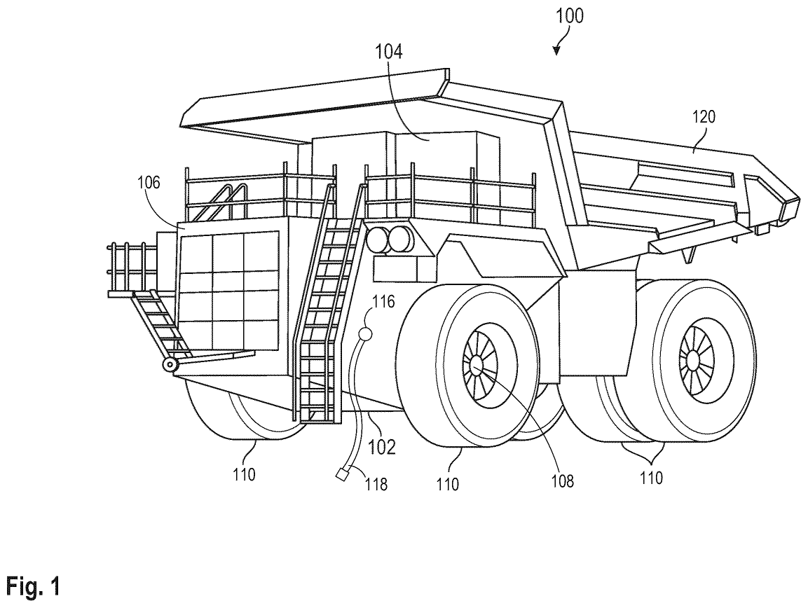

FIG. 1 is a perspective view of an example machine 100 described herein. While in FIG. 1, the machine 100 is depicted as a mining truck, the machine 100 may be another type of machine, such as a haul truck, a vehicle, a compactor machine, a paving machine, a cold planer, a grading machine, a backhoe loader, a wheel loader, a harvester, an excavator, a motor grader, a skid steer loader, a tractor, a dozer, a locomotive machine (e.g., a switcher locomotive, a mainline freight train, etc.), a marine machine (e.g., a ferry, a tugboat, a cargo vessel, etc.), or the like. The machine 100 may be a manned machine or an unmanned machine. The machine 100 may be fully-autonomous, semi-autonomous, or remotely operated. The machine 100 may include one or more batteries 102, one or more parasitic components 104, a testing control system 106, one or more motors 108, a propulsion system 110, and/or a charging connection point 116.

The machine 100 may be configured to be at least partially powered by the battery 102. For example, the machine 100 may be a battery electric machine (BEM), a battery electric vehicle (BEV), a hybrid vehicle, a fuel cell and battery hybrid vehicle, or another machine that is at least partially powered by the battery 102. The machine 100 may include one or more electric engines, one or more electric drive motors (or other electric motors), one or more electrical conversion systems, and/or other electrical components that are configured to convert and/or use energy, such as energy stored in the battery 102, to cause overall movement of the machine 100 across a work site and/or to cause movement of individual components or systems of the machine 100.

The battery 102 may include one or more batteries, such as one or more lithium-ion (Li-ion) batteries, lithium-ion polymer batteries, nickel-metal hydride (NiMH) batteries, lead-acid batteries, nickel cadmium (Ni—Cd) batteries, zinc-air batteries, sodium-nickel chloride batteries, or other types of batteries. In some implementations, multiple battery cells may be grouped together, in series or in parallel, within a battery module. Multiple battery modules may be grouped together, such as in series, within a battery string. One or more battery strings may be provided within a battery pack, such as a group of battery strings linked together in parallel. Accordingly, the battery 102 may include one or more battery packs, one or more battery strings, one or more battery modules, and/or one or more battery cells. The battery 102 may be associated with one or more electrical components (not shown in FIG. 1) of the machine 100, such as one or more electric power buses and/or one or more electric power converters, which may facilitate providing (or not providing) power to one or more other components or systems of the machine 100 from the battery 102.

The motor 108 may be an electric motor configured to various components of the machine 100. For example, the motor 108 may be an electric drive motor configured to drive the propulsion system 110. The motor 108 can be configured to convert electrical energy from the battery 102 into power for operating various elements (e.g., the propulsion system 110) of the machine 100.

The parasitic components 104 may include devices or systems of the machine 100 that draw power from the battery 102. For example, the parasitic components 104 may include one or more pumps, one or more chillers, one or more heaters, one or more fans, or the like. In one example, a thermal regulation system for the battery 102 may include one or more parasitic components 104. For example, the thermal regulation system may include one or more pumps, one or more chillers, one or more heaters, and/or one or more fans.

The propulsion system 110 may include one or more propulsion components of the machine 100. The one or more propulsion components may include, for example, a drive train (e.g., that includes a transmission), wheels, axles, tracks, or other components that are configured to facilitate propulsion of the machine 100 (e.g., movement of the machine 100 at a work site). For example, the propulsion system 110 may include one or more electric drive motors, electrically connected to the battery 102, configured to operate wheels and/or tracks of the machine 100.

The charging connection point 116 may be a wired or wireless energy transfer interface. For example, the charging connection point 116 may be an electrical plug, outlet, connector, charging port, or other wired electrical energy transfer interface that can be physically connected to an electrical power connector component 118 (e.g., that is configured to provide power to the battery 102 to charge the battery 102). As another example, the charging connection point 116 may be an inductive charging pad or other type of wireless energy transfer interface that can transfer energy wirelessly from the electrical power connector component 118. The charging connection point 116 may be located at a front of the machine 100, at a back of the machine 100, on a side of the machine 100, or at any other position on the machine 100.

The electrical power connector component 118 may include an energy transfer connector that is configured to attach to the charging connection point 116. The electrical power connector component 118 may be a wired or wireless energy transfer interface that is compatible with the charging connection point 116. For example, the electrical power connector component 118 may be an electrical plug, outlet, connector, charging port, or other wired electrical energy transfer interface that can be physically connected to the charging connection point 116. As another example, the electrical power connector component 118 may be an inductive charging pad or other type of wireless energy transfer interface that can transfer energy wirelessly to the charging connection point 116. Accordingly, when the electrical power connector component 118 is connected to the charging connection point 116, current can flow from a power source (e.g., that generates and/or provides electric power) through the electrical power connector component 118 to the charging connection point 116, which allows the electrical power connector component 118 to be connected (e.g., electrically connected) and to charge the battery 102, as described herein.

As shown in FIG. 1, the machine 100 may include a bed 120 for hauling material to and from a work site. In other examples, the machine 100 may include an implement (not shown), such as an earthmoving implement (e.g., a blade, a bucket, or a scoop), a paving implement (e.g., a screed, a cutting drum, or a compaction drum), an agricultural implement, or another type of implement.

As described herein, the testing control system 106 is configured to monitor a performance metric (such as a capacity, a charge, an energy, a resistance, etc.), relating to the battery 102.

As indicated above, FIG. 1 is provided as an example. Other examples may differ from what is described in connection with FIG. 1.

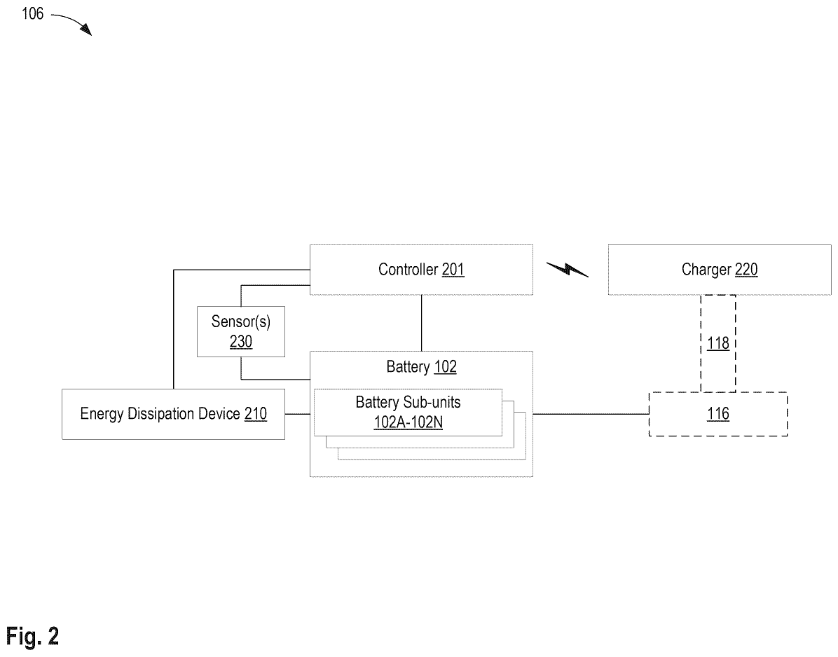

FIG. 2 is a diagram of an example of the testing control system 106. The testing control system 106 includes a controller 201, the battery 102, one or more energy dissipation devices 210, one or more chargers 220, and one or more sensors 230.

The controller 201 is provided for electrically controlling various aspects of the machine 100. For example, the controller 201 can send and receive signals from various components of the machine 100 during various operations of the machine 100. The controller 201 may include one or more memories and one or more processors communicatively coupled to the one or more memories. A processor may include a central processing unit, a graphics processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. The processor may be capable of being programmed to perform one or more operations or processes described elsewhere herein. A memory may include volatile and/or nonvolatile memory. For example, the memory may include random access memory (RAM), read only memory (ROM), a hard disk drive, and/or another type of memory (e.g., a flash memory, a magnetic memory, and/or an optical memory). The memory may be a non-transitory computer-readable medium. The memory may store information, one or more instructions, and/or software (e.g., one or more software applications) related to the operation of the controller 201. The controller 201 may perform one or more operations described herein. As described herein, the controller 201 is a component of the machine 100. However, in some implementations, the controller 201 may be a component of the charger 220, and operations described herein may be performed at the charger 220.

The battery 102 may be any energy storage device configured to supply electrical power for operation of various components of the machine 100. For example, the battery 102 may be configured to operate one or more electric drive motors of the machine 100. As shown in FIG. 2, the battery 102 may include a plurality of battery sub-units 102A through 102N. Each of the battery sub-units 102A-N may be or include one or more battery cells, battery modules, battery strings, and/or battery packs. Each of the battery sub-units 102A-N may be configured to include one or more types of batteries, such as Li-ion batteries, Li-ion polymer batteries, NiMH batteries, lead-acid batteries, Ni-Cd batteries, zinc-air batteries, sodium-nickel chloride batteries, or other types of batteries. In some implementations, any number of the battery sub-units 102A-N may be grouped together, in series or in parallel, within a battery module. Any number of battery modules may be grouped together, such as in series, within a battery string. One or more battery strings may be provided within a battery pack, such as a group of battery strings linked together in parallel. Accordingly, the battery sub-units 102A-N may form one or more battery packs, one or more battery strings, one or more battery modules, and/or one or more battery cells. One or more of the battery sub-units 102A-N may be associated with one or more electrical components of the machine 100, such as one or more electric power buses and/or one or more electric power converters, which may facilitate providing (or not providing) power to one or more other components or systems of the machine 100 and/or facilitate energy transfer between various components (e.g., buses, batteries, etc.).

The sensor 230 may be one or more sensing devices configured to measure an electrical property of the battery 102. For example, the sensor 230 may be configured to detect and/or measure battery-related parameters such as a voltage, a current, a temperature, a state of charge (SoC), a state of health (SoH), or any electrical property indicative of a capacity of the battery 102 (and/or of the battery sub-units 102A-N). In some embodiments, the testing control system 106 may include a battery management system (BMS) (not shown) configured to monitor and/or control the battery 102 of the machine 100. For example, the BMS may include and/or be operatively coupled with the sensor 230 to monitor and/or control the battery 102.

The energy dissipation device 210 may be arranged on the machine 100 and electrically connected to the battery 102. The energy dissipation device 210 may be configured to discharge the battery 102. The energy dissipation device 210 may be or include the parasitic component 104, a resistor grid, or another component configured to convert or transfer an electrical energy stored in the battery 102 into another form or medium (e.g., heat). As discussed below, the controller 201 can control the energy dissipation device 210 to perform a performance test of the battery 102.

The charger 220 may be any device configured to supply electrical energy to the battery 102. The charger 220 may be an external charger configured to operate independently from the battery 102 and connect with the battery 102 as needed. For example, the charger 220 may be a disconnectable charger configured to connect to an outlet providing alternating current (AC) power and convert into direct current (DC) power to charge the battery 102 via the charging connection point 116. The charger 220 may include or be operatively coupled with the electrical power connector component 118. In some embodiments, the charger 220 may be or include the energy dissipation device 210. For example, the charger 220 may be a bidirectional charger. In this case, the energy dissipation device 210 can discharge the battery 102 and store the energy from the battery 102 and/or send the energy from the battery 102 to an electrical grid. In some cases, the energy dissipation device 210 can return the stored energy to the battery 102 to charge the battery 102, serving as a charger 220. In some examples, an engine of the machine 100 may serve as a charger 220. With the engine of the machine 100 serving as the charger 220, the engine can be operatively coupled to the battery 102 such that the engine can charge the battery 102 while running. In some examples, the engine of the machine 100 may serve as an energy dissipation device 210. With the engine of the machine 100 serving as the energy dissipation device 210, the engine can be motored by the battery 102, discharging the battery 102.

During operation of the machine 100, or at another time, the controller 201 may detect that the charging connection point 116 of the machine 100 is connected to the charger 220. This detection may be based on various signals, such as an electrical connection signal, a voltage or current flow indication, or a communication signal exchanged between the machine 100 and the charger 220. For instance, the controller 201 may monitor the charging connection point 116 of the machine 100 for a change in electrical potential, the presence of a charging signal, or a confirmation from a BMS indicating an active charging session or an electrical connection.

The controller 201 may initiate, based on detecting that the charging connection point 116 is connected to the charger 220, a performance test for the battery 102 while the battery 102 is connected to the machine 100. As used herein, the term “performance test” may refer to any operation to determine a performance metric for the battery 102 (e.g., a capacity of the battery 102), based on, for example, a battery characteristic or an electrical property of the battery 102. The controller 201, to initiate the performance test, may send a control signal or a command to at least one of the energy dissipation device 210, the charger 220, or the battery 102 (or the BMS).

In some examples, the controller 201 may receive an input instructing the initiation of the performance test. For example, the input may be received from an operator via a user interface, such as a touchscreen display or a physical control panel. The input may be received from a remote place (e.g., a real-time request, a queued remote request, etc.). This allows for external control via a fleet management system or a remote monitoring interface, thereby enhancing operational flexibility and enabling proactive battery health management across multiple machines. In some implementations, the input may be generated by a higher-level control system or the controller 201 itself, based on a detection of a predetermined condition. For example, the input may be generated periodically or in response to a detection of an abnormal behavior (e.g., rapid voltage drops, excessive temperature rise, inability to hold charge, erratic charge/discharge cycles that deviate from expected performance, etc.) of the battery 102. In response to receiving the input and based on detecting that the charging connection point 116 is connected to the charger 220, the controller 201 may initiate the performance test. In some examples, the controller 201 may automatically initiate the performance test based on predetermined conditions, such as a scheduled maintenance interval (e.g., every 500 operating hours, every six months, after a predetermined number of charge-discharge cycles, etc.), a battery usage pattern (e.g., frequent short charging sessions, prolonged high-load operations, irregular deep discharges, etc.), real-time diagnostic data (e.g., sudden voltage drops, abnormal temperature fluctuations, increased internal resistance, etc.), etc. This automation can help ensure consistency in testing procedures without requiring manual intervention.

In some examples, the controller 201 may select a battery sub-unit 102A, of the battery sub-units 102A-N, for the performance test. For example, the controller 201 may select the battery sub-unit 102A based on the input indicating that the performance test is to be performed for the battery sub-unit 102A. The controller 201 may initiate the performance test for the selected battery sub-unit.

In some examples, the controller 201 may detect an electrical fault associated with one or more of the battery sub-units 102A-N. The controller 201 may analyze data received from the sensor 230, the BMS, or the battery sub-units 102A-N to detect the electrical fault associated with the battery sub-unit 102A. For example, the controller 201 may identify anomalies in a voltage, a current, an internal resistance, etc., indicative of the electrical fault of the battery sub-unit 102A. The controller 201 may select the battery sub-unit 102A based on detecting the electrical fault, and initiate the performance test for the selected battery sub-unit.

In some examples, the controller 201 may determine whether the machine 100 is to undergo the performance test. The determination may be based on various conditions, such as a SoC of the battery 102, a recent usage history of the machine 100, an ambient temperature, maintenance schedules for the machine 100 or other machines in a fleet with the machine 100, or any indication in the input or from the BMS. For example, the controller 201 may determine an elapsed time from a previous performance test, and determine whether the elapsed time satisfies (e.g., is greater than or equal to) a threshold. The controller 201 may determine that the machine 100 is to undergo the performance test, based on determining that the elapsed time satisfies the threshold. Additionally, or alternatively, the controller 201 may assess system diagnostics, such as error codes, deviations in expected energy performance, etc., to determine whether the machine 100 is to undergo the performance test. The controller 201 may initiate the performance test based on determining that the machine 100 is to undergo the performance test.

The controller 201 may schedule the performance test based on machine or fleet tasks, charger availability, and/or other operational factors. For example, the controller 201 may include a scheduler configured to optimize the timing of the performance test by considering factors such as the duration since the last performance test, the occurrence of specific events, and/or the current maintenance schedule of the machine 100. For example, the controller 201 may determine that the performance test should be conducted as part of routine maintenance or in response to a detected decline in the SoH of the battery 102 or a remaining battery life. In some examples, the controller 201 may initiate the performance test based on external conditions, such as environmental factors (e.g., a temperature, an altitude, etc.), load demands (e.g., an operational intensity and/or duration of the machine 100, periods of low or fluctuating loads that can influence the battery behavior, etc.), etc.

The controller 201 may initiate the performance test during various operations of the machine 100. For example, the controller 201 may determine that the machine 100 is to undergo maintenance unrelated to the battery 102, such as servicing of mechanical components or software updates. The controller 201 may determine that the machine 100 is to undergo the performance test concurrently with the maintenance. By leveraging planned maintenance periods, the testing control system 106 can perform the performance test without interrupting normal operation of the machine 100, allowing the battery diagnostics to be conducted without running additional dedicated testing times.

In some examples, the controller 201 may determine whether the charger 220 is available for the performance test. For instance, the controller 201 may determine whether the charger 220 is supplying power to another system, whether the charger 220 meets the power and voltage requirements for conducting the performance test, etc. The controller 201 may communicate with the charger 220 to verify the operational status of the charger 220, and/or to determine the charger 220 is available for the performance test. The controller 201 may initiate the performance test based on determining that the charger 220 is available for the performance test.

The controller 201 may initiate the performance test using data relating to a fleet of machines that includes the machine 100. For example, the controller 201, to determine whether the charger 220 is available for the performance test, may identify respective SoCs associated with one or more additional machines in the fleet with the machine 100. The controller 201 may determine, based on the respective SoCs, whether the charger 220 will be available for a duration of the performance test. For example, the controller 201 may estimate an earliest time when another machine in the fleet will need to use the charger 220 based on the respective SoCs, and based on the estimated earliest time, determine when the charger 220 will no longer be available (e.g., a time when the charger 220 will need to be used by the other machine to re-charge its battery). The controller 201 may initiate the performance test based on determining that the charger 220 will be available for the duration of the performance test. Alternatively, the controller 201 may determine that a duration that the charger 220 will be available is insufficient to perform the performance test for the battery 102. Here, the controller 201 may select one or more of the battery sub-units 102A-N based on determining that the duration is insufficient and/or determining that the duration is sufficient to perform the performance test for the battery sub-unit(s) (e.g., because a battery sub-unit can be tested in less time than the entire battery 102). The controller 201 may initiate the performance test for the selected battery sub-unit. In this way, the available time of the charger 220 can be utilized efficiently to facilitate testing of at least some of the battery sub-units 102A-N, even if the entire battery 102 cannot be tested in the amount of available time.

The controller 201 may perform conditioning operations for the battery 102, prior to the initiation of the performance test, to accurately obtain the performance metric of the battery 102 by standardizing testing conditions across performance tests.

For example, the controller 201 may detect, prior to the initiation of the performance test, whether a temperature of the battery 102 is within a temperature range used for the performance test. The controller 201 may receive temperature data relating to the battery 102 from the sensor 230 (e.g., a temperature sensor configured to monitor the temperature of the battery 102) or the BMS. The controller 201 may cause, based on detecting that the temperature is not within the temperature range, activation of a battery thermal management system (not shown) to heat or cool the battery 102, thereby bringing the temperature to within the temperature range suitable for the performance test. For example, the controller 201 may transmit a signal to the battery thermal management system or BMS to control the temperature of the battery 102. The battery thermal management system or BMS may include or be operatively coupled with heating pads, cooling fans, liquid cooling systems, or any other component configured to regulate the temperature. In some examples, the controller 201 may cause, in preparation for the performance test, charging of the battery 102 to an upper charge level that is used for the performance test (e.g., if the battery 102 is not already at the upper charge level). The controller 201 may transmit a control signal to the charger 220, etc. to charge the battery 102 to the upper charge level (e.g., 100% charge).

The controller 201 may be ready to perform the performance test for the battery 102 after determining that the performance test is to be initiated, selecting the battery 102 or one or more battery sub-units 102A-N for the performance test, and/or providing suitable conditions for the performance test. The controller 201 may perform the performance test while the battery 102 is connected to the machine 100 (e.g., the battery 102 is not removed from the machine 100 or otherwise moved from its normal position in order to perform the performance test). The controller 201 may monitor, during the performance test for the battery 102 and while the battery 102 is connected to the machine 100, an electrical property of the battery 102. The electrical property may be or include a voltage, a current, a power, and/or an internal resistance, among other examples, of the battery 102.

At an outset of the performance test, the battery 102 may be charged to the upper charge level, as described herein. Accordingly, the controller 201 may cause, for the performance test, discharging of the battery 102 to a lower charge level (e.g., 0% charge) to obtain discharge data indicating the electrical property during discharging of the battery 102. The controller 201 may obtain the discharge data from the sensor 230. The controller 201 may cause discharging of the battery 102 to the lower charge level using the energy dissipation device 210. For example, the controller 201 may activate the dissipation device 210 (e.g., a parasitic component 104, a resistor grid, another battery on a separate bus of the machine 100, a different sub-unit of the battery 102, or a bidirectional charger) to cause the dissipation device 210 to draw current from the battery 102, thereby discharging the battery 102. The discharge data may include a discharging voltage profile (e.g., a voltage drop over time), a discharging current profile (e.g., a current draw over time), a discharge duration (e.g., a time taken to reach the lower charge level), an energy output (e.g., a total energy delivered by the battery 102), a temperature variation (e.g., a heat generated during discharge), a SoH indicator (e.g., deviations from expected discharge behavior indicating a battery aging or degradation), etc. The controller 201 may cause discharging of the battery 102 to the lower charge level in accordance with a discharge rate (e.g., by controlling a speed or intensity of the dissipation device 210) that is standardized across performance tests, thereby facilitating repeatable performance testing that produces accurate results. In some examples, the controller 201 may control the discharge rate. For example, the controller 201 may slow down the discharge rate at the end of the discharge. The sensor 230 or the BMS associated with battery 102 may monitor parameters, such as a voltage, a current, and/or a temperature, during the discharge process, and provide the discharge data to the controller 201.

In some examples, the controller 201, to cause discharging of the battery 102 to the lower charge level, may change a current flow direction via the energy dissipation device 210 (e.g., a bidirectional charger, a resistor grid, another battery on a separate bus of the machine 100, a different sub-unit of the battery 102, or a parasitic component 104). For example, the controller 201 may control the energy dissipation device 210 to change the current flow from a first direction (e.g., in which the current flows from the energy dissipation device 210 to the battery 102) to a second direction (e.g., in which the current flows from the battery 102 to the energy dissipation device 210), thereby discharging the battery 102.

After the discharging cycle, the controller 201 may cause, for the performance test, charging of the battery 102 to (e.g., back to) the upper charge level (e.g., 100% charge) to obtain charge data indicating the electrical property during charging of the battery 102. The controller 201 may obtain the charge data from the sensor 230. The controller 201 may cause charging of the battery 102 back to the upper charge level using the charger 220. The charge data may include a charging voltage profile (e.g., a voltage as a function of time), a charging current profile (e.g., a current as a function of time), a charge duration (e.g., a time taken to reach the upper charge level), an energy input (e.g., a total energy supplied to the battery 102), a temperature variation (e.g., changes in battery temperature during charging), a SoC indicator (e.g., a percentage increase in charge level over time), etc. The controller 201 may cause charging of the battery 102 back to the upper charge level in accordance with a charge rate that is standardized across performance tests, thereby facilitating repeatable performance testing that produces accurate results. In some embodiments, the controller 201 may control the charge rate.

For example, the controller 201 may slow down the charge rate at the end of the charge. The sensor 230 or the BMS associated with battery 102 may monitor parameters, such as a voltage, a current, and a temperature, during the charge process, and provide the charge data to the controller 201. The controller 201 may conduct the performance test in various mods (e.g., a low-power capacity evaluation mode, a full-power system performance evaluation mode, etc.). In some implementations, the controller 201 may conduct the performance test in the low-power capacity evaluation mode, by charging and/or discharging the battery 102 at a controlled rate. In the low-power capacity evaluation mode, the controller 201 may determine the capacity of the battery 102, the internal resistance, the overall health, etc. with minimal impact on the system operations. In other implementations, the controller 201 may conduct the performance evaluation mode by charging and/or discharging the battery 102 under actual operating conditions (e.g., charge and/or discharge rate similar to a rate for operations of the machine; while interacting with power electronics, thermal management systems, the charger 220, etc.). The controller 201 may identify cooling inefficiencies, unexpected voltage drops, charge time deviations, etc. in the performance evaluation mode.

The controller 201 may determine, using the discharge data and the charge data, a performance metric for the battery 102. The performance metric may include an indication of the overall health and/or effectiveness of the battery 102 in storing and delivering energy. For example, the performance metric may include the capacity of the battery 102. As an example, a round trip efficiency may be determined based on the total energy discharged during the performance test (e.g., during a discharge cycle) relative to the energy supplied during the performance test (e.g., during a charge cycle). The controller 201 can determine the capacity of the battery 102 based on the determined efficiency. In some implementations, the controller 201 may determine both the charge and discharge capacity of the battery 102. The controller 201 may determine if a charge capacity is different from a discharge capacity. The controller 201 may determine capacity losses (e.g., incurred from internal resistance changes, thermal effects, conversion inefficiencies, etc.) based on a discrepancy in the capacity. In some embodiments, the controller 201 may monitor internal resistance rise, which can serve as an indicator of battery degradation, either through direct measurement of voltage drop versus current at the terminals or inferred from temperature rise and heat rejection by the cooling system. In addition, the controller 201 may account for external losses, including parasitic energy consumption and cable losses, to determine an overall charging efficiency metric.

In some examples, the controller 201 may perform the performance test on one or more battery sub-units 102A-N by utilizing a split-bus architecture, which enables an energy transfer between the battery sub-units 102A-N. For example, when the performance test is for a first battery sub-unit 102A of the battery 102, the controller may cause discharging of the first battery sub-unit 102A to a second battery sub-unit 102B of the battery 102. This internal energy transfer allows for a controlled and efficient discharge process while reducing energy loss (e.g., dissipating the energy externally). The internal energy transfer also allows for the performance test to be performed without the use of the charger 220, thereby enabling performance testing in remote areas lacking charger access or at times when the charger 220 is unavailable. During charging, the controller 201 may cause charging of the first battery sub-unit 102A to the upper charge level by the second battery sub-unit 102B of the battery 102. This split-bus charging and discharging approach enhances energy efficiency, while enabling independent performance assessment of each battery sub-unit 102A-N without dissipating the energy externally. The controller 201 may monitor electrical properties of one or more of the battery sub-units 102A-N during the performance test, and determine a performance metric for one or more of the battery sub-units 102A-N, as described herein. The battery 102 may include, for the split-bus charging and discharging approach, power electronics components, an onboard storage device, a bidirectional converter, and/or a switching circuit to regulate the flow of energy between the battery sub-units 102A-N. While the charging and discharging operations are discussed as non-limiting examples, the controller 201 may cause charging and/or discharging of the battery 102 in various manners. In some examples, the controller 201 may cause discharging of the battery 102 through one or more of the charger 220, the energy dissipation device 210, the parasitic component 104, a resistor grid, another battery independent from the battery 102, etc.). In some examples, the controller 201 may cause charging of the battery 102 through one or more of the charger 220, the energy dissipation device 210, through another battery independent from the battery 102, etc.

The controller 201 may output information indicating the capacity of the battery 102. For example, the controller 201 may generate the information based on the results of the performance test. The controller 201 may output the information to display on a user interface, store in a data log, or transmit to a remote monitoring system for fleet management. The output may include the performance metric, capacity values, etc.

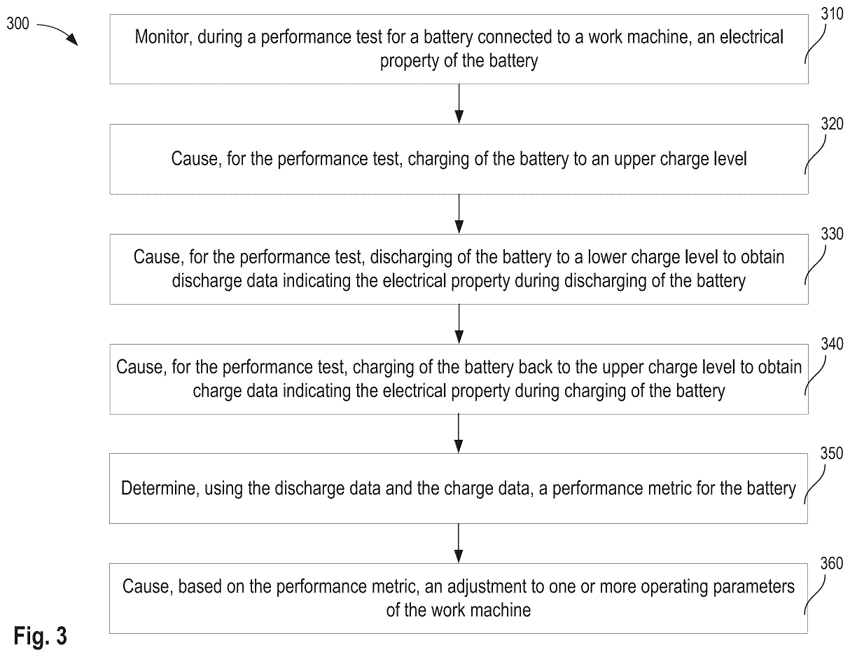

FIG. 3 is a flowchart of an example method 300. One or more steps of the method 300 may be performed by one or more controllers (e.g., the controller 201). Additionally, or alternatively, one or more steps of the method 300 may be performed by another device or a group of devices separate from or including the controller(s), such as another device or component that is internal or external to the machine 100.

At step 310, the method 300 may include monitoring, by a controller (e.g., the controller 201) and during a performance test for a battery (e.g., the battery 102) connected to a work machine (e.g., the machine 100), an electrical property of the battery.

At step 320, the method 300 may include causing, by the controller (e.g., the controller 201) for the performance test, charging of the battery to an upper charge level (e.g., 100% charge). At step 330, the method 300 may include causing, by the controller (e.g., the controller 201) for the performance test, discharging of the battery to a lower charge level (e.g., 0% charge) to obtain discharge data indicating the electrical property during discharging of the battery.

At step 340, the method 300 may include causing, by the controller (e.g., the controller 201) for the performance test, charging of the battery back to the upper charge level (e.g., 100% charge) to obtain charge data indicating the electrical property during charging of the battery.

At step 350, the method 300 may include determining, by the controller (e.g., the controller 201) and using the discharge data and the charge data, a performance metric for the battery (e.g., a capacity of the battery).

At step 360, the method 300 may include causing, by the controller (e.g., the controller 201) and based on the performance metric, an adjustment to one or more operating parameters of the work machine. The adjustment to the one or more operating parameters may adjust an acceleration power of the work machine, a speed or a torque of a motor of the work machine, a temperature of a cooling or a heating system of the work machine, a charge/discharge power, and/or an intensity of an environment control system (e.g., a cabin climate control, an air filtration, a lighting), among other examples. For example, the method 300 may include causing the adjustment to a throttle response (e.g., limiting an acceleration power when the capacity is low to reduce a high current draw), a speed and load limitation (e.g., reducing a maximum speed or torque when the capacity is low to extend the battery life), a power distribution (e.g., adjusting a power allocation between drive motors to optimize efficiency), a cooling system (e.g., controlling battery cooling fans or coolant flow to maintain an optimal temperature and prevent thermal runaway), a heat dissipation system (e.g., modifying a motor or inverter operation to generate less heat), a dynamic charge rate (e.g., slowing down or speeding up charging based on a temperature and a battery health), a SoC limit control (e.g., preventing deep discharge by limiting how low the battery drains before triggering low-power modes), a charger (e.g., the charger 220), an energy dissipation device (e.g., the energy dissipation device 210), and/or an energy allocation system (e.g., reducing a power to non-essential systems, such as a cabin climate control, an air filtration, a lighting, etc. when the battery capacity is low), among other examples. In some examples, the adjustment to the one or more operating parameters may set a full power for charging or discharging during the performance test, set a lower power for energy testing, etc.

Although FIG. 3 shows example steps of the method 300, in some implementations, the method 300 may include additional steps, fewer steps, different steps, or differently arranged steps than those depicted in FIG. 3. Additionally, or alternatively, two or more of the steps of the method 300 may be performed in parallel.

### INDUSTRIAL APPLICABILITY

The testing control system 106 described herein may be used with any electrical machinery that operates based on batteries (e.g., the battery 102) or any hybrid variations that include a battery as an energy source. In particular, the testing control system 106 may be used in a battery-electric machine that operates at a worksite or other setting to improve battery management. For example, the testing control system 106 may be used in a haul truck, a vehicle, a compactor machine, a paving machine, a cold planer, a grading machine, a backhoe loader, a wheel loader, a harvester, an excavator, a motor grader, a skid steer loader, a tractor, a dozer, or another type of work machine that performs road surfacing operations, earth moving operations, or the like. Unlike diesel-powered machines, battery-electric machines may be limited by battery capacity constraints, impacting operating duration and efficiency. While onboard systems may track battery degradation, accuracy may be affected by sensor uncertainty and indirect measurements. Premature replacement increases costs, while prolonged use of degraded batteries can harm performance and cause unexpected failures. Efficient battery management is useful for optimizing performance, reducing costs, and ensuring reliable operation of the machine 100.

The testing control system 106 enhances the efficiency of the machine 100 while improving maintenance planning and operational reliability. The testing control system 106 can initiate a performance test based on system parameters, operator input, or fleet management scheduling, ensuring seamless integration into maintenance workflows while accounting for charger availability. During the performance test, the testing control system 106 can charge the battery 102 of the machine 100 to an upper level (e.g., 100% SoC), discharge to a lower level (e.g., 0% SoC), and then recharge to the upper level (e.g., 100% SoC), while monitoring electrical properties to determine performance metrics such as battery capacity. By utilizing controlled charge and discharge rates, the testing control system 106 can prevent excessive heat generation and inefficiency, ensuring consistent and reliable test results. Moreover, the testing control system 106 can perform a performance test while the battery 102 is connected to the machine 100 and the machine 100 is connected to the charger 220, thereby facilitating performance testing without disassembly of the machine 100 or removal of the battery 102 from the machine 100, which are complex and time-consuming operations that increase machine downtime. Performing the performance test while the machine 100 is connected to the charger 220 takes advantage of planned downtime, thereby maximizing operational time for the machine 100. Furthermore, the control system 106 utilizes equipment on the machine 100, such as the energy dissipation device 210 (e.g., a parasitic component 104, an onboard storage device, or a resistor grid) and/or an energy source device (e.g., one or more of the battery sub-units 102A through 102N for the split-bus charging and discharging approach), to perform the performance test, thereby avoiding specialized testing equipment being installed on the machine 100.

Thus, the controlled testing process enables accurate and repeatable performance assessments without requiring battery removal, minimizing downtime, and eliminating the need for additional testing equipment. Additionally, it allows for better forecasting of the battery lifespan, optimized maintenance scheduling, and improved fleet utilization. Accordingly, the testing control system 106 provides improved battery health management, extends the service life of the machine 100, and reduces unplanned downtime.

What is claimed is:

1. A testing control system for a work machine, comprising:
a battery configured to operate one or more electric drive motors of the work machine;
a sensor configured to measure an electrical property of the battery;
an energy dissipation device arranged on the work machine and electrically connected to the battery; and
a controller configured to:
detect that a charging connection point of the work machine is connected to a charger;
initiate, based on detecting that the charging connection point is connected to the charger, a performance test for the battery while the battery is connected to the work machine;
cause, for the performance test, charging of the battery to an upper charge level;
cause, for the performance test, discharging of the battery to a lower charge level using the energy dissipation device to obtain, from the sensor, discharge data indicating the electrical property during discharging of the battery;
cause, for the performance test, charging of the battery back to the upper charge level to obtain, from the sensor, charge data indicating the electrical property during charging of the battery;
determine, using the discharge data and the charge data, a capacity of the battery; and
output information indicating the capacity of the battery.

2. The testing control system of claim 1, wherein the controller is further configured to:
detect, prior to initiation of the performance test, whether a temperature of the battery is within a temperature range used for the performance test; and
cause, based on detecting that the temperature is not within the temperature range, activation of a battery thermal management system to heat or cool the battery.

3. The testing control system of claim 1, wherein the controller, to cause discharging of the battery to the lower charge level, is configured to cause discharging of the battery to the lower charge level in accordance with a discharge rate that is standardized across performance tests, and
wherein the controller, to cause charging of the battery back to the upper charge level is configured to cause charging of the battery back to the upper charge level in accordance with a charge rate that is standardized across performance tests.

4. The testing control system of claim 1, wherein the controller is further configured to:
receive an input instructing initiation of the performance test,
wherein the controller, to initiate the performance test, is configured to initiate the performance test further based on the input.

5. The testing control system of claim 1, wherein the battery includes multiple battery sub-units, and the controller is further configured to:
select a battery sub-unit of the multiple battery sub-units for the performance test; and
initiate the performance test for the selected battery sub-unit.

6. The testing control system of claim 5, wherein the controller, to select the battery sub-unit, is configured to:
detect an electrical fault associated with the battery sub-unit; and
select the battery sub-unit based on detecting the electrical fault.

7. The testing control system of claim 5, wherein the controller, to select the battery sub-unit, is configured to:
identify respective states of charge (SoCs) associated with one or more additional work machines in a fleet with the work machine;
determine, based on the respective SoCs, a duration that the charger will be available;
determine that the duration is insufficient to perform the performance test for the multiple battery sub-units of the battery; and
select the sub-unit based on determining that the duration is insufficient.

8. The testing control system of claim 1, wherein the upper level is 100% charge and the lower level is 0% charge.

9. A work machine, comprising:
a propulsion system;
an electric drive motor configured to drive the propulsion system;
a battery configured to operate the electric drive motor; and
a controller configured to:
monitor, during a performance test for the battery while the battery is connected to the work machine, an electrical property of the battery;
cause, for the performance test, discharging of the battery to a lower charge level to obtain discharge data indicating the electrical property during discharging of the battery;
cause, for the performance test, charging of the battery to an upper charge level to obtain charge data indicating the electrical property during charging of the battery; and
determine, using the discharge data and the charge data, a performance metric for the battery.

10. The work machine of claim 9, wherein the performance test is for a first battery sub-unit of the battery, and
wherein the controller, to cause discharging of the battery to the lower charge level, is configured to cause discharging of the first battery sub-unit to a second battery sub-unit of the battery.

11. The work machine of claim 9, wherein the performance test is for a first battery sub-unit of the battery, and
wherein the controller, to cause charging of the battery to the upper charge level, is configured to cause charging of the first battery sub-unit by a second battery sub-unit of the battery.

12. The work machine of claim 9, wherein the performance metric is capacity.

13. The work machine of claim 9, wherein the controller, to cause discharging of the battery to the lower charge level, is configured to change a current flow via a bidirectional charger, a resistor grid, or a parasitic component.

14. The work machine of claim 9, wherein the controller is further configured to:
detect that a charging connection point of the work machine is connected to a charger;
determine whether the work machine is to undergo a performance test; and
initiate the performance test based on determining that the work machine is to undergo the performance test.

15. The work machine of claim 14, wherein the controller, to determine whether the work machine is to undergo the performance test, is configured to:
determine an elapsed time from a previous performance test;
determine whether the elapsed time satisfies a threshold; and
determine that the work machine is to undergo the performance test, based on determining that the elapsed time satisfies the threshold.

16. The work machine of claim 14, wherein the controller is further configured to:
determine that the work machine is to undergo maintenance unrelated to the battery; and
determine that the work machine is to undergo the performance test concurrently with the maintenance.

17. The work machine of claim 9, wherein the controller is further configured to:
detect that a charging connection point of the work machine is connected to a charger;
determine whether the charger is available for the performance test; and
initiate the performance test based on determining that the charger is available for the performance test.

18. The work machine of claim 17, wherein the controller, to determine whether the charger is available for the performance test, is configured to:
identify respective states of charge (SoCs) associated with one or more additional work machines in a fleet with the work machine; and
determine, based on the respective SoCs, whether the charger will be available for a duration of the performance test,
wherein the controller, to initiate the performance test, is configured to initiate the performance test based on determining that the charger will be available for the duration of the performance test.

19. A method, comprising:
monitoring, by a controller and during a performance test for a battery connected to a work machine, an electrical property of the battery;
causing, by the controller for the performance test, charging of the battery to an upper charge level;
causing, by the controller for the performance test, discharging of the battery to a lower charge level to obtain discharge data indicating the electrical property during discharging of the battery;
causing, by the controller for the performance test, charging of the battery back to the upper charge level to obtain charge data indicating the electrical property during charging of the battery;
determining, by the controller and using the discharge data and the charge data, a performance metric for the battery; and
causing, by the controller and based on the performance metric, an adjustment to one or more operating parameters of the work machine.

20. The method of claim 19, wherein the adjustment to the one or more operating parameters is to at least one of: an acceleration power of the work machine, a speed or a torque of a motor of the work machine, a temperature of a cooling or a heating system of the work machine, or an intensity of an environment control system.
